(19) United States
(12) Patent Application Publication
(10) Pub. No.: US 2005/0109400 A1
(43) Pub. Date: May 26, 2005

(54) Thermal isolator for a valve and actuator assembly

(76) Inventors: William H. Glime, Painesville, OH (US); Howard C. B. Kuhns, P.E., Aurora, OH (US); Daniel E. Zeiler, Mentor, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/897,659

(22) Filed: Jul. 22, 2004

Related U.S. Application Data
(60) Provisional application No. 60/481,141, filed on Jul. 25, 2003.

(51) Int. Cl. F16K 49/00

(52) U.S. Cl. 137/334

(57) ABSTRACT

A thermal isolator for a valve and an actuator includes a coupler that is adapted to be disposed between the valve and the actuator and to connect the actuator to the valve. The thermal isolator is adapted to increase the temperature gradient between the valve and the actuator when one of the valve and the actuator is exposed to an elevated or reduced temperature.

### RELATED APPLICATIONS

This application claims the benefit of pending U.S. Provisional patent application Ser. No. 60/481,141, filed on Jul. 25, 2003 for THERMALLY ISOLATED VALVE ACTUATOR, the entire disclosure of which is fully incorporated herein by reference.

### BACKGROUND OF THE INVENTION

Valves are used to control fluid flow, for example, inline in a fluid stream. A typical valve assembly may include a movable valve element and an actuator. The actuator may be a manually, pneumatically, hydraulically, or electrically controlled device operative to control the position of the movable valve element relative to a valve seat on a valve body through which the fluid stream flows. The position of the movable valve element controls fluid flow through the valve.

Some valves are used in applications in which the temperature of the fluid stream is controlled so that it does not vary. In such a case, the valve body may be heated or cooled to maintain the desired temperature of the fluid flowing through the valve. Heat transfer between the valve and its actuator, which is attached to the valve body, can cause heat to be added to or drawn off from the valve body. This can generate undesirable temperature gradients in a heated or cooled valve body (i.e., variations in temperature over relatively small distances), thereby increasing the power consumption required to maintain the valve body and thus the fluid stream at the desired temperature.

### SUMMARY OF THE INVENTION

One aspect of the present invention is to thermally isolate or increase the thermal resistance between the valve actuator from the fluid stream in the valve body by reducing the heat transfer between the valve and its actuator. An added benefit of such thermal isolation is enabling the use of a valve actuator that has temperature limitations; that is, an actuator that otherwise could not feasibly be used on a valve body that is subject to undesired temperature conditions (heat or cold) from the process fluid. In addition, a valve can be operated over a larger temperature range if the actuator does not draw off or add heat.

Thermal isolation of the actuator can also permit the use of temperature sensitive devices, such as electronic position indicators, sensors, communication devices, and electric actuators, that are otherwise not feasibly used with a valve operating in a hot or cold temperature environment. Finally, thermal isolation of the actuator improves the ability to heat uniformly the fluid stream (via a heated valve body) and reduces power consumption required to maintain desired valve temperature.

An embodiment of the current invention comprises a thermal isolator for a valve and an actuator assembly. The thermal isolator includes a coupler that is adapted to be disposed between the valve and the actuator and to connect the actuator to the valve. The thermal isolator is adapted to increase the temperature gradient between the valve and the actuator when one of the valve and the actuator is exposed to an elevated or reduced temperature.

### BRIEF DESCRIPTION OF THE DRAWINGS

These and other aspects of the invention will be described herein and readily understood by those skilled in the art from a reading of the detailed description and the accompanying drawings wherein:

FIG. 1 illustrates a general schematic of a valve and actuator assembly with a thermal isolator, in accordance with an embodiment of the present invention;

FIG. 2 is a sectional view of a valve and actuator assembly with a thermal isolator, in accordance with a more specific embodiment of the present invention;

FIG. 3 is an infrared video image of comparative high temperature testing of the valve and actuator assembly of FIG. 2 and a valve and actuator assembly assembled without a thermal isolator.

FIG. 4 is a sectional view of a thermal isolator for a valve and actuator assembly, in accordance with another embodiment of the present invention;

FIG. 5 is a sectional view of a thermal isolator for a valve and actuator assembly, in accordance with an additional embodiment of the present invention;

FIG. 6 is a sectional view of a thermal isolator for a valve and actuator assembly, in accordance with yet another embodiment of the present invention;

FIG. 7 is a sectional view of a thermal isolator for a valve and actuator assembly, in accordance with a further embodiment of the present invention; and

FIG. 8 is a sectional view of mating male and female threads for a valve and actuator assembly, adapted in accordance with an embodiment of the present invention.

### DESCRIPTION OF EXEMPLARY EMBODIMENTS OF THE INVENTION

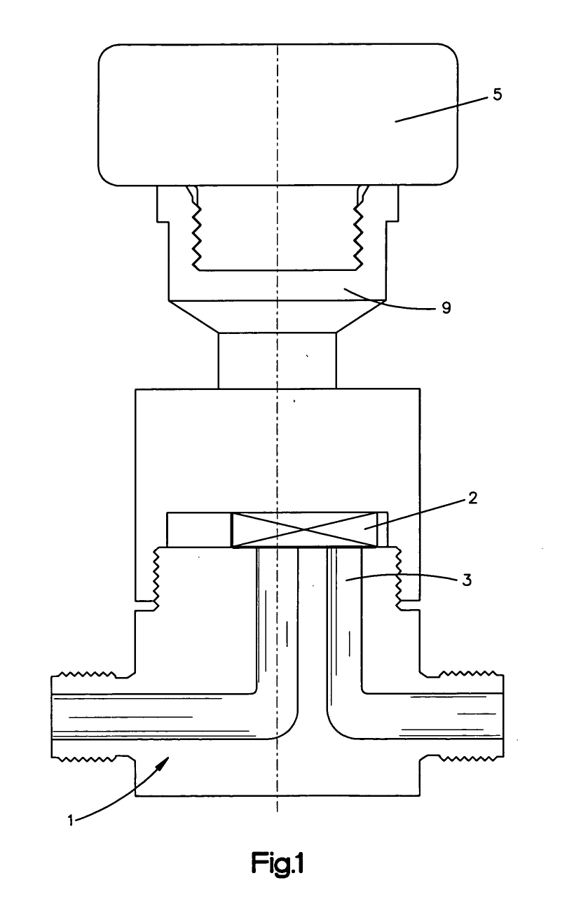

The present invention is directed to thermal isolation of valves and operably coupled actuators. By thermal isolation we mean decreasing the thermal conductivity between two bodies such as a flow control device and actuator. Thermal isolation is not intended to be limited to complete thermal separation (i.e. zero thermal conductivity). The invention is applicable to various valve and actuator constructions. Several embodiments of the invention are illustrated, and other embodiments will be apparent to those skilled in the art. As representative of the present invention, FIG. 1 illustrates a schematic of an actuated valve assembly according to a more general embodiment of the invention. A valve 1 provides a means of controlling flow in a fluid system (not shown) by providing a movable valve element 2 that may be moved relative to a fluid flow passage 3, in order to increase, decrease, or eliminate flow through the valve. An actuator 5 is assembled to the valve to provide a means for operating the movable valve element 2.

The embodiment of FIG. 1 is provided with a coupler 9, which is disposed between the valve 1 and the actuator 5. In the pictured embodiment, the coupler 9 mechanically joins the actuator 5 to the valve 1 through mating threaded surfaces; however, any type of mechanical connection or coupling may be used between the coupler 9 and the valve 1 and actuator 5. Examples include welded connections, press-fit connections, quick disconnect couplings, and clamp fittings.

The principal function of the coupler 9 is to thermally isolate the valve 1 and actuator 5 by reducing the thermal conductivity therebetween. The thermal isolation of the valve 1 and actuator 5 is primarily effected through three features of coupler 9. First is physical separation (increased distance) between valve 1 and actuator 5 that reduces heat flow between valve 1 and actuator 5. Second is a reduction in the cross-sectional area available for heat transfer in a section of the coupler 9, which increases the thermal gradient (change in temperature as a function of distance) across the coupler. Third is the use of materials of construction in the coupler 9 that exhibit sufficient structural integrity and possess a relatively low thermal conductivity that reduces the transmission of heat between valve 1 and actuator 5. In addition to reducing heat flow between valve 1 and actuator 5, the added physical separation between valve 1 and actuator 5 allows externally applied insulation (foam wrap, heater blanket, etc.) to be conveniently applied to the valve 1 or actuator 5 independently.

The coupler may serve one or both of two functions in isolating the thermal properties of the valve 1 and the actuator 5. First, the coupler 9 may provide a displacement or distance separation between the valve 1 and actuator 5 to reduce the exposure to the actuator 5 of the elevated or reduced temperature of the valve 1. Second, the coupler 9 may act as a thermal barrier between the valve 1 and the actuator 5. This may be accomplished through the use of materials having both structural integrity at high temperatures and low thermal conductivity. Such materials may include, but are not limited to: low thermal conductivity plastics, such as polybenzimidizole (PBI) and polyimide (PI); structural ceramic materials, such as zircon, zircona, YAG, and glasses; stainless steels; porous metals and other porous materials; and reinforced composites, such as glass-fiber reinforced plastic. Use of these types of materials allows the coupler to more effectively reduce heat transfer to or from the components with which it engages. A thermal barrier may also be provided by adapting the structure of the coupler 9 to reduce the contact area or the cross-sectional area of adjoining components, thereby providing less material through which heat transfer can occur. While the distance separation increases the temperature differential between the valve and actuator by further separating the actuator from the source of the elevated or reduced temperature, the reduced cross sections and contact surfaces increase the temperature differential by increasing the thermal gradient (change in temperature as a function of distance). Thus, a coupler in accordance with the invention further contemplates the concept of providing thermal isolation between a valve and an actuator operably coupled therewith.

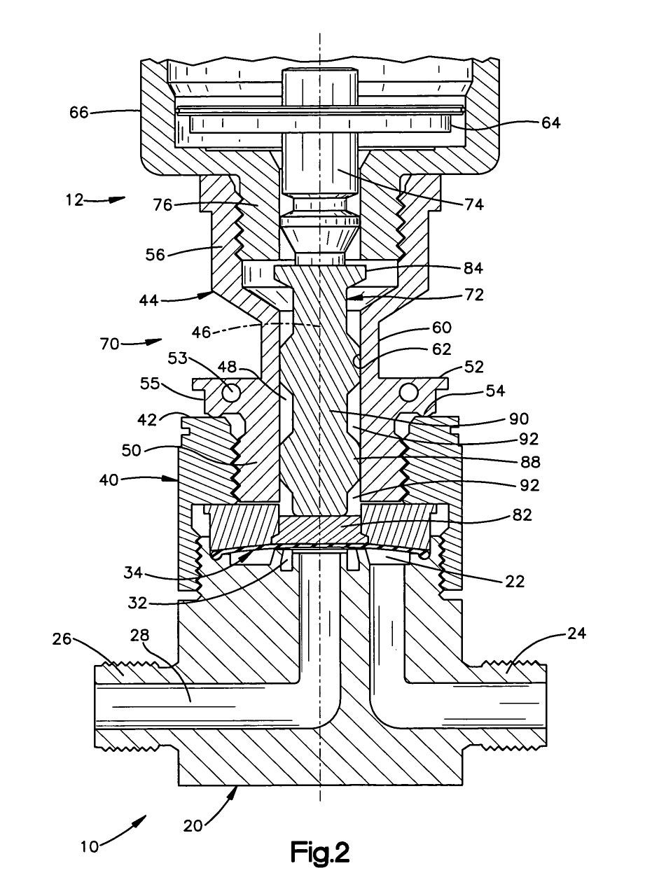

In a more detailed embodiment, FIG. 2 illustrates an actuated valve assembly with a thermal isolator in accordance with another embodiment of the invention. The valve 10 is a radial diaphragm valve having a pneumatic actuator 12. While the invention is illustrated with respect to a pneumatic actuator 12 in a radial diaphragm valve 10, the invention may be used with other valve actuator designs and other valve designs. The various aspects of the invention as set forth herein may be used individually or in various combinations with each other and with other valve and valve actuator designs, with the illustrated embodiments being intended to be exemplary in nature and not limiting as to use.

The valve 10 includes a valve body 20. The valve body 20 defines a valve cavity 22 in the valve body. The valve body 20 may include a fluid inlet 26 and a fluid outlet 24; however, it is contemplated that flow through the valve may be bidirectional, and that the present invention may be used with valve configurations having more than one inlet or outlet port. The fluid inlet 26, the fluid outlet 24, and the valve cavity 22 together form a fluid flow passage 28 in the valve 10. In the embodiment of FIG. 2, the fluid flow passage 28 includes a variable orifice defined by the area between a valve seat 32 and a diaphragm 34.

The metal diaphragm 34 is secured in the valve body 20, and is movable axially between an open position and a closed position relative to the valve seat 32. Again, it should be noted that the use of any type of movable valve element, such as a bellows, needle stem, or plug with drilled orifice, is contemplated by the present invention. The invention is not limited to metal diaphragms.

The valve assembly of FIG. 2 includes a bonnet nut 40 having an upper surface 42 that is presented away from the valve body 20. A coupler 44 supports the actuator 12 on the bonnet nut 40 and, thereby, on the valve body 20. The coupler 44 thus acts as a linkage between valve and actuator, supporting the actuator 12 at a greater distance from the valve body 20, as described below. The coupler 44 may be made from a single piece of material, and may be constructed of a material having both structural integrity at elevated temperatures and low thermal conductivity, such as the materials listed above. However, the coupler may also comprise multiple components or multiple materials, which may allow for minimization of both heat transfer across the coupler and thermal expansion of the coupler at elevated temperatures. The coupler 44 of the embodiment of FIG. 2 has an elongated, tubular configuration centered on an axis 46 and defining an internal passage 48, although the shape of the coupler and the position of the passage may be varied to better accommodate the type of valve and actuator used.

The coupler 44 has an externally threaded first end portion 50 that is screwed into the bonnet nut 40. A stop flange 52 extends radially outward from the first end portion 50 and has a bead or ring offset 54. When the coupler 44 is screwed into the bonnet nut 40, the bead or ring offset 54 on the stop flange 52 of the coupler engages the upper surface 42 of the bonnet nut 40 to limit movement of the coupler relative to the bonnet nut 40. The engagement of the stop flange 52 with the bonnet nut 40 acts as a mechanical stop to position the coupler 44 properly relative to the valve body 20. The flange 52 may have one or more holes 53 for receiving a thermal element for heating or cooling the valve, or a recess 55 for receiving a cord heater. These heating or cooling elements (not shown) may assist in providing a more uniform temperature throughout the valve while still allowing for a large thermal gradient across the coupler.

The coupler 44 has an internally threaded second end portion 56 and an intermediate portion 60 that is located between the first and second end portions 50 and 56. The intermediate portion 60 of the coupler 44 has a thin walled configuration (i.e., the average wall thickness of the intermediate portion is less than the average wall thicknesses of the first and second end portions), with a cylindrical inner surface 62 centered on the axis 46, although the shape of the intermediate portion may be varied to better accommodate the type of valve and actuator used. Also, the intermediate portion may be adapted to have a smaller outer diameter than the outer diameters of the first and second end portions.

The actuator 12 illustrated in FIG. 2 is a pneumatic actuator having a piston 64 located in a housing 66. An isolation assembly 70 is interposed between the actuator housing 66 and the bonnet nut 40. The isolation assembly 70 includes the coupler 44 and a plunger 72. The actuator housing 66 is screwed into the coupler 44 as described below, to position the actuator 12 farther from the valve body 10 and to provide a thermal barrier between the valve and actuator.

The actuator 12 of FIG. 2 includes a shaft 74 that is fixed for movement with the piston 64 and that projects toward the diaphragm 34. The piston 64 has an outer end face to which air under pressure can be applied to move the piston and the shaft 74 axially in the housing 66. A lower end portion 76 of the actuator housing 66 is screwed into the second end portion 56 of the coupler 44. As a result, the actuator shaft 74 is located in the internal passage 48 of the coupler 44 and is presented toward the diaphragm 34.

The plunger 72 extends axially through the internal passage 48 of the coupler 44. The plunger 72 may be made from a single piece of material, as depicted in FIG. 2, which would preferably be constructed of a material having a low thermal conductivity and structural integrity at elevated temperatures, such as the example materials listed above. However, the plunger 72 may also be constructed of multiple components in different materials. For example, the plunger may consist of multiple linking sections disposed in series within the internal passage 48, which may or may not be attached to each other, where some of the sections are constructed of materials having a low thermal conductivity, while other sections are constructed of materials having structural integrity at elevated temperatures. Also, the plunger may comprise a rod of high strength material surrounded by a sheath made of a material having low thermal conductivity (not shown).

The plunger 72 of FIG. 2 has a valve end engaging a button 82 that abuts the center of the diaphragm 34. The plunger 72 has an opposite actuator end 84 that engages with the actuator shaft 74. As a result, the plunger 72 acts as a linking element and connects the diaphragm 34 with the actuator 12 in a force-transmitting relationship; the plunger can transmit motive force from the actuator to the diaphragm. In other words, movement of the piston and shaft (a movable actuation element) is translated to the diaphragm (a movable valve element) via the plunger (a linking element).

An intermediate section of the plunger 72 of FIG. 2 has some portions 88 that have a relatively large cross-sectional area. These wider portions 88 of the plunger 72 engage the cylindrical inner surface 62 of the intermediate portion 60 of the coupler 44. The wider portions 88 may engage the inner surface 62 around an entire circumference of the wider portions 88, or they may only engage the inner surface at discrete locations on the wider portions 88. This engagement supports the plunger 72 for sliding movement relative to the coupler 44, along the axis 46.

The wider portions 88 of the plunger 72 are interspersed with narrow portions 90 of the plunger that have a reduced, or relatively small, cross-sectional area. The plunger 72 is spaced radially inward from, and is out of engagement with, the coupler 44, at the locations of the narrow portions 90 of the plunger. Thus, continuous gaps 92 exist between the plunger 72 and the coupler 44 at the narrow portions 90. As a result there is not continuous contact between the plunger 72 and the coupler wall for the full length of the intermediate portion 60 of the coupler 44.

The extended length of the plunger 72 and of the coupler 44 provide greater spacing (distance) between the valve body 20 and the actuator 12, thus helping to isolate the actuator thermally from the valve body. The lengths of these components may be varied to provide a preferred displacement of the actuator from the valve. In addition, the reduced cross section of the narrow plunger portions 90 slows heat transfer along the length of the plunger, resulting in a higher thermal gradient across the coupler. Similarly, the smaller outer diameter and the thin wall 60 of the coupler 44 slows heat transfer along its length by reducing the amount of material available as a conductive pathway. In addition, the radial gaps 92 between the plunger 72 and the coupler 44 reduce heat transfer by reducing the contact area between those two parts.

Also, the bead or ring offset 54 reduces heat transfer at the joint between the bonnet nut 40 and the coupler 44. Controlling the contact area at mechanical stops such as this one can assist with reducing the heat transfer characteristics of a valve-actuator coupling. Any type of raised portion on the flange may be used, as features like offsets, nodules, rings, dimples, deltas, etc. allow mechanical stops to be made with minimal area of contact between mating parts.

The physical displacement (extended spacing) of the actuator 12 from the valve body 20 also makes it easier to add a heating or cooling means, such as a heater wrap, to the valve body, without contacting the valve actuator as well.

The isolation assembly 70 shown in FIG. 2 (including the coupler or extended bonnet 44, and the long plunger 72), can be readily adapted to existing valves assemblies and thus can be retrofitted to products already manufactured or in service, using the same valve body 20 and parts of the actuator 12. By providing an isolation assembly having connections or couplings that mate with the mating actuator and valve connections of an existing valve assembly, the isolation assembly may be added to the valve assembly during initial assembly in the factory or through routine maintenance in the field.

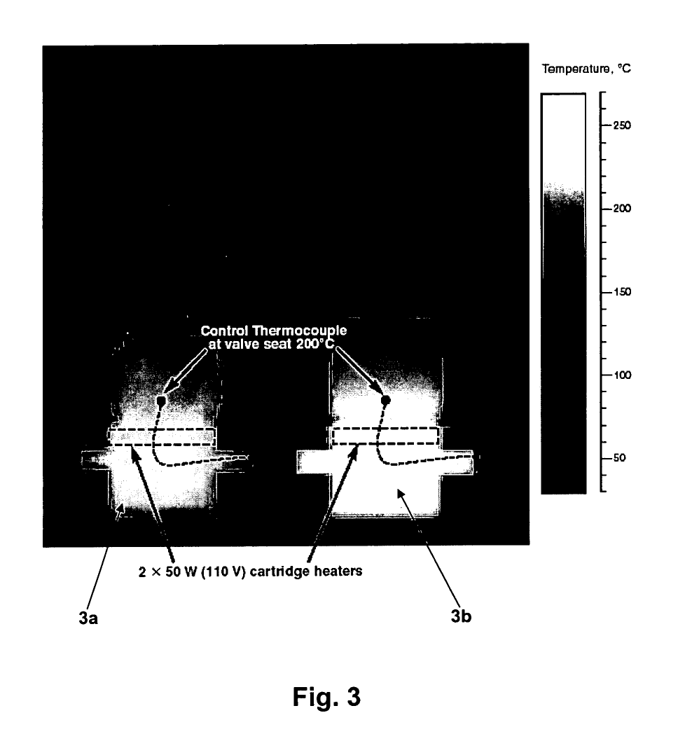

FIG. 3 illustrates the temperature profile results of high temperature testing of the actuated valve of FIG. 2, depicted at 3a, and the same actuated valve assembled without the isolation assembly 70, depicted at 3b. Both valve body seats and diaphragms were maintained at a temperature of 200° C. as measured by thermocouples at the valve seats, through the use of heat cartridges inserted in the valve bodies, and an infrared video camera was used to measure the temperature profiles across the valves and actuators. No additional insulating materials were used on the external surfaces of the valve assemblies. The varying shades of the valve assemblies shown in the infrared image depicted in FIG. 3 indicate valve temperatures corresponding to the temperatures shown in the accompanying temperature scale of FIG. 3. The thermally isolated actuated assembly 3a produced a temperature differential of greater than 100° C. from the valve seat just below the isolation assembly) to the base of the actuator (at the opposite end of the isolation assembly). In contrast, the non-thermally isolated assembly 3b produced a temperature differential of approximately 30° C. across the same distance, with an even smaller temperature differential between the valve seat and the base of the non-displaced actuator. Further, due to the increased heat transfer from the valve to the actuator in the non-thermally isolated assembly 3b, the valve body had to be heated to much higher temperatures (above 270° C. compared to approximately 220° C. for the thermally isolated assembly 3a) in order to maintain the 200° C. valve seat temperature, resulting in inconsistent temperatures across the flow path of the valve, and more than twice the required power to the heat cartridge to maintain this temperature. Therefore, the isolation assembly utilized in the actuated valve assembly of FIG. 3A produced a greater than 100° C. reduction in maximum actuator temperature, a greater than 50° C. reduction in the temperature differential between the valve seat and the maximum valve body temperature, and a greater than 50% reduction in the power required to maintain the valve seat at 200° C.

FIG. 4 illustrates a valve 100 and actuator 102 in accordance with another embodiment of the invention. A bonnet nut 104 forms an upper part of the valve 100. The bonnet nut 104 has an internal thread convolution 107. A movable actuation element is shown schematically at 103, and a movable valve element is shown schematically at 106. The linking element, connecting the actuation element 103 to the valve element 106 is shown schematically at 105 and is representative of other parts of the valve and valve actuator that are not shown because the thermal isolation features are usable with numerous valves or valve actuators.

The actuator 102 includes a housing 108 having a relatively wide upper portion 110 and a relatively narrow lower end portion 112. The lower end portion 112 of the actuator housing 108 has an external thread convolution 116 that matches the internal thread convolution 107 on the bonnet nut 104. Thus, the actuator housing 108 is adapted to screw directly into the bonnet nut 104. As indicated above, and as with any of the threaded connections herein described, the actuator and valve may be adapted to be connected by any number of types of connections, including welded connections, press-fit connections, quick disconnect couplings, and clamp fittings.

The actuator housing 108 is not, however, connected directly to the bonnet nut 104. Instead, an isolation assembly 120 is interposed between the actuator housing 108 and the bonnet nut 104. The isolation assembly 120 includes a bonnet adapter 122, an actuator adapter 124, a coupler 126, and two thermal insulating members 128 and 130.

The bonnet adapter 122 of FIG. 4 is a sleeve or collar that has a lower end portion 132 and an upper end portion 134. The lower end portion 132 of the bonnet adapter 122 has an external thread convolution and is screwed into the bonnet nut 104, thus effectively lengthening the bonnet nut. The upper end portion 134 of the bonnet adapter 122 has a radially extending shoulder 138 adjacent the thread convolution. The shoulder 138 engages the bonnet nut 104 to provide a mechanical stop between the bonnet nut and the bonnet adapter 122.

The upper end portion 134 of the bonnet adapter 122 also has an annular flange 140 that projects radially outward at the upper terminal end of the bonnet adapter. The diameter of the flange 140 on the bonnet adapter 122 is selected so that the flange is radially co-extensive (i.e., overlapping) with the actuator adapter 124 when the actuator adapter is screwed onto the actuator housing 108 as described below.

The actuator adapter 124 of FIG. 4 is a sleeve or collar that has internal and external thread convolutions. The actuator adapter 124 is screwed onto the lower end portion 112 of the actuator housing 108, thus effectively giving the lower end portion of the actuator housing a larger diameter. The actuator adapter 124 has a radially extending flange 146 at its upper end.

The coupler 126 of FIG. 4 is a cylindrical member having an internal thread convolution on its upper end portion 150. The thread convolution is adapted to mate with the external thread convolution on the actuator adapter 124. The lower end portion 152 of the coupler 126 is formed as a radially inwardly extending flange having a diameter substantially equal to that of the flange 140 on the bonnet adapter 122.

The flange 152 of the coupler 126 is located between the bonnet nut 104 and the flange 140 of the bonnet adapter 122. The first thermal insulating member 130 is located between the flange 152 of the coupler 126 and the flange 140 of the bonnet adapter 122. The first thermal insulating member 130 is made from a thermally insulating material and acts as a gasket or washer between the bonnet adapter 122 and the coupler 126. A variety of different thermal insulating materials can be used to optimize thermal isolation and mechanical coupling of the actuator 102 and the valve 100, including the materials listed above as having structural integrity at elevated temperatures and low thermal conductivity.

The second thermal insulating member 128 is located between the actuator adapter 124 and the flange 140 of the bonnet adapter 134. The second thermal insulating member 128 is made from a thermally insulating material and acts as a gasket or washer between the bonnet adapter 134 and the actuator adapter 124.

The actuator adapter 124 is screwed into the coupler 126 until the flange 146 on the actuator adapter engages the upper end portion 150 of the coupler 126. The flange 140 of the bonnet adapter 122, together with the upper and lower thermal insulators 128 and 130, is clamped (or sandwiched) between the actuator adapter 124 and the flange 152 of the coupler 126. The thickness of the actuator adapter flange 146 may be modified to provide a greater displacement between the actuator 102 and the valve 100.

The actuator housing 108 is thus mechanically supported on and fixed to the coupler 126. The coupler 126 is clamped to the flange 140 of the bonnet adapter 122, which is mechanically supported on and fixed to the bonnet nut 104. As a result, the actuator 102 is mechanically supported on and fixed to the bonnet nut 104, and the actuator adapter 124 is thermally insulated from the bonnet nut 104 by the first and second thermal insulating members 128 and 130.

The actuator 102 is supported at a greater distance from the bonnet nut 104 than if it were screwed directly into the bonnet nut, but not so great a distance as in, for example, the embodiment of FIG. 2. As a result, thermal isolation of the actuator 102 from the bonnet nut 104 is achieved in a relatively low profile assembly.

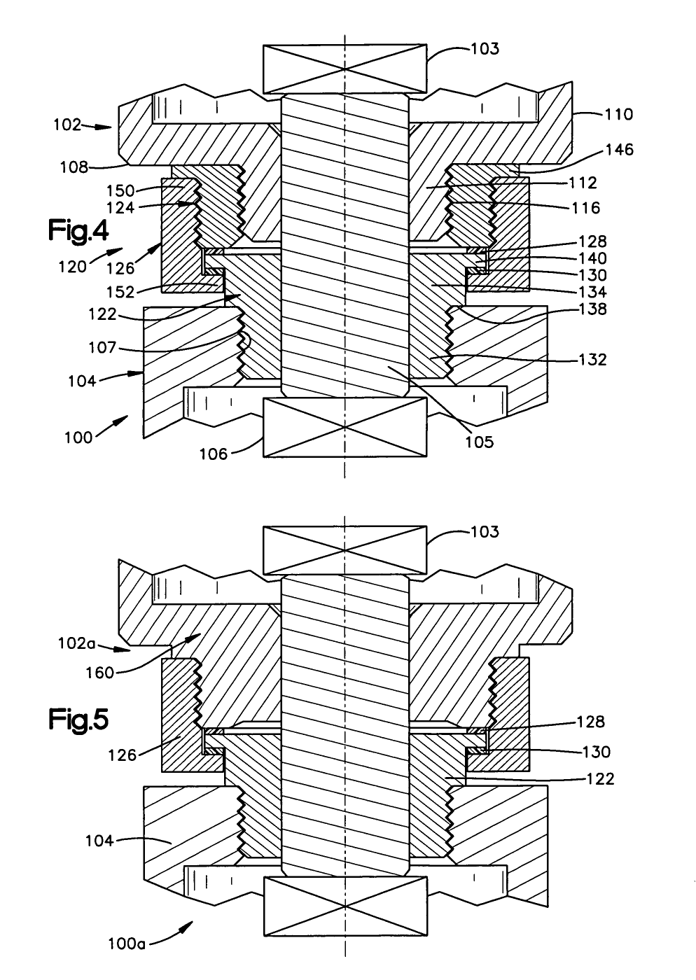

FIG. 5 illustrates an assembly of a valve 100a and valve actuator 102a in accordance with a fourth embodiment of the invention. In the assembly of FIG. 5, the actuator housing and actuator adapter are formed as one piece designated 160 in FIG. 5, while the same coupler, thermal insulating members and bonnet adapter used in FIG. 4 may be used to form the isolation assembly. This assembly thus has the advantage of having fewer overall pieces, but in return may require a different (non-standard) actuator housing. Alternatively or additionally, the bonnet nut and bonnet adapter of FIGS. 4 and 5 may be formed as one piece to reduce the number of components in the assembly, with the same coupler 126 and thermal insulating members 128, 130 used to join the assemblies (not shown).

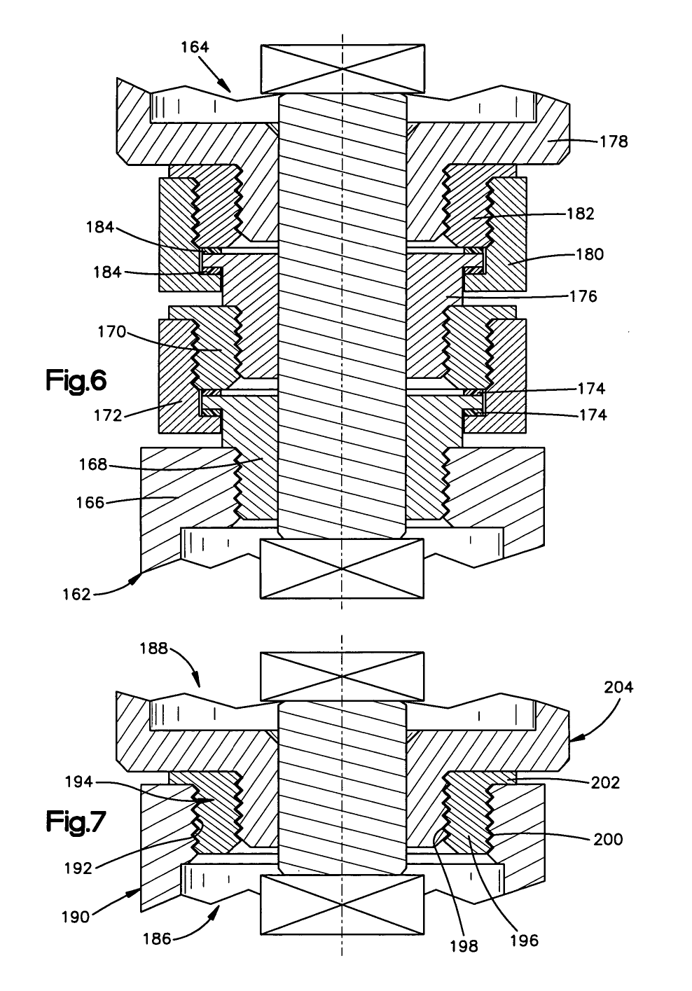

FIG. 6 illustrates an assembly of a valve 162 and valve actuator 164 in accordance with a fifth embodiment of the invention. The assembly is similar to that shown in FIG. 4 but with an additional stage of thermal isolation (i.e., multiple thermal isolation subassemblies, each including a set of the thermal isolation assembly components) between the valve 162 and the actuator 164.

Specifically, the assembly includes a bonnet 166 into which a first bonnet adapter 168 is screwed. The first bonnet adapter 168 is coupled mechanically with a first actuator adapter 170 by a first coupler 172. The first bonnet adapter 168 is isolated thermally from the first actuator adapter 170 by first and second thermal insulating members 174.

A second bonnet adapter 176 is screwed into the actuator adapter 170. The second bonnet adapter 176 is coupled with the actuator housing 178 by a second coupler 180 and a second actuator adapter 182. The second bonnet adapter 176 is isolated thermally from the actuator housing 178 by third and fourth thermal insulating members 184. The resulting assembly has an extra stage or subassembly of thermal insulation between the valve bonnet 166 and the actuator housing 178, but is taller. As many subassemblies as are desired can be used.

FIG. 7 illustrates an assembly of a valve 186 and valve actuator 188 in accordance with a sixth embodiment of the invention. The assembly includes a valve bonnet nut 190 that has an internally threaded opening 192. The assembly also includes a thermal insulator or coupler 194. The coupler 194 has a cylindrical main body portion 196 with internal and external thread convolutions 198 and 200. The thermal insulator 194 has a flange 202 that extends radially outward from the upper end of the main body portion 196.

The coupler 194 is screwed into the valve bonnet nut 190. The flange 202 on the coupler 194 engages the upper end surface of the bonnet nut 190 to provide a mechanical stop.

The actuator housing 204 is screwed into the coupler 194. The actuator housing 204 engages the flange 202 of the coupler 194 to provide a mechanical stop and clamp the thermal insulator between the actuator housing and the bonnet nut 190. The coupler 194 thus provides a mechanical connection between the actuator housing 204 and the bonnet nut 190. The coupler 194 also provides a heat barrier between the actuator housing 204 and the bonnet nut 190. The coupler 194 may be constructed of a material having structural integrity at elevated temperatures structural and a low thermal conductivity, such as the materials listed above, to further reduce heat transfer from the valve to the actuator. Also, the thickness of the flange 202 may be modified to vary the distance separation between the valve and the actuator.

A thermal insulator of this type may take different forms and be located elsewhere in a valve and actuator assembly, for example, at various locations between the parts of the assembly.

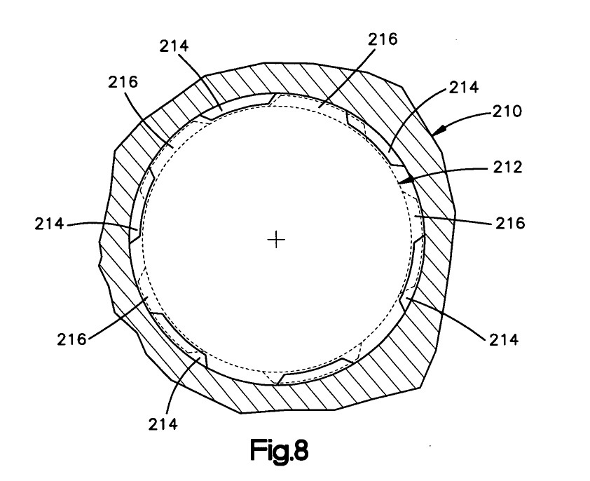

FIG. 8 illustrates an additional feature that can be used to enhance thermal isolation of parts in a valve and actuator assembly. Specifically, first and second parts 210 and 212 of the valve assembly are threadedly engaged. The thread on the first part 210 is discontinuous, providing circumferentially spaced thread sections 214. The thread on the second part 212 also is discontinuous, providing circumferentially spaced thread sections 216. The discontinuities minimize the contact area between the mating components 210 and 212, thus providing a thermal barrier. An assembly may also be provided with discontinuous threads on only one of the two mating parts, with standard threads on the other part. This feature may be applied to any of the described embodiments to further contribute to the thermal isolation between the valve and actuator.

To aid in reducing heat transfer between the valve body and the valve actuator, one or more of the pre-existing parts of the valve or valve actuator may be manufactured from a material with relatively low thermal conductivity (e.g., plastic, ceramic, metal). Such a part would act as a thermal separator between its adjacent components, and its relatively low conductivity would help to thermally isolate the valve and the actuator. This can provide the additional advantage of a zero or modest increase in the height of the valve assembly, as compared to adding an additional part.

From the above description of the invention, those skilled in the art will perceive improvements, changes, and modifications in the invention. Such improvements, changes, and modifications within the skill of the art are intended to be included within the scope of the appended claims.

1. A thermal isolator for a valve and an actuator, the thermal isolator comprising:
a coupler, adapted to be disposed between the valve and the actuator and to connect the actuator to the valve, wherein
the coupler is adapted to increase the temperature gradient between the valve and the actuator when one of the valve and the actuator is exposed to an elevated or reduced temperature.

2. The thermal isolator of claim 1, wherein the coupler further comprises one of a hole or a recess adapted for receiving a thermal element.

3. The thermal isolator of claim 1, wherein the coupler is constructed of a material having structural integrity at elevated temperatures and a low thermal conductivity.

4. The thermal isolator of claim 1, wherein the coupler has a first end, a second end, an intermediate portion therebetween, and an internal passage extending from the first end to the second end and defining an inner surface.

5. The thermal isolator of claim 4, wherein the first end, the second end, and the intermediate portion each have an average wall thickness, the average wall thickness of the intermediate portion being less than the average wall thicknesses of the first and second ends.

6. The thermal isolator of claim 4, wherein the first end, the second end, and the intermediate portion each have an outer diameter, and the outer diameter of the intermediate portion is less than the outer diameter of the first and second ends.

7. The thermal isolator of claim 4, further comprising a linking element, wherein at least a portion of the linking element is disposed in the internal passage of the coupler.

8. The thermal isolator of claim 7, wherein the linking element has an actuator end, a valve end, and an intermediate section therebetween, and the intermediate section of the linking element has a wider portion that contacts the inner surface of the coupler and a narrower portion that provides a continuous gap between the narrow portion and the inner surface.

9. The thermal isolator of claim 7, wherein the linking element comprises a plurality of separate linking sections disposed in series within the internal passage of the coupler.

10. The thermal isolator of claim 9, wherein at least one of the plurality of linking sections possesses a lower thermal conductivity than the remaining linking sections.

11. The thermal isolator of claim 7, wherein at least one of the coupler and the linking element is constructed of a material having structural integrity at elevated temperatures and a low thermal conductivity.

12. A valve and actuator assembly, the assembly comprising:
a valve;
an actuator; and
a coupler, disposed between the valve and the actuator and adapted to connect the actuator to the valve, wherein the coupler adapted to increase the temperature gradient between the valve and the actuator when one of the valve and the actuator is exposed to an elevated or reduced temperature.

13. The assembly of claim 12, wherein the coupler positions the actuator at a predetermined distance from the valve.

14. The assembly of claim 12, wherein the coupler further comprises one of a hole or a recess adapted for receiving a thermal element.

15. The assembly of claim 12, wherein the coupler is constructed of a material having high temperature structural integrity and a low thermal conductivity.

16. The assembly of claim 12, wherein the coupler further comprises a stop flange that abuts against a surface of the valve.

17. The assembly of claim 16, wherein the stop flange comprises a raised portion that contacts the surface of the valve.

18. The assembly of claim 17, wherein the raised portion is a ring offset.

19. The assembly of claim 17, wherein the raised portion is a series of nodules.

20. The assembly of claim 12, further comprising a bonnet adapter, assembled to the valve, wherein the coupler engages with the bonnet adapter to provide a connection between the coupler and the valve.

21. The assembly of claim 20, wherein the coupler and bonnet adapter are provided with overlapping annular flanges.

22. The assembly of claim 21, further comprising a thermal insulating member disposed between the overlapping flanges of the coupler and bonnet adapter.

23. The assembly of claim 21, further comprising a thermal insulating member disposed between an end surface of the actuator and the annular flange of the bonnet adapter.

24. The assembly of claim 21, further comprising an actuator adapter, assembled to the actuator, wherein the coupler engages with the actuator adapter to provide a connection between the coupler and the actuator.

25. The assembly of claim 24, wherein the coupler and actuator adapter are provided with mating threaded portions.

26. The assembly of claim 24, further comprising a thermal insulating member disposed between an end surface of the actuator adapter and the annular flange of the bonnet adapter.

27. The assembly of claim 12, wherein the coupler comprises a first end assembled to the actuator, a second end assembled to the valve, and an intermediate portion disposed between the first and second ends.

28. The assembly of claim 27, wherein the first end, the second end, and the intermediate portion each have an outer diameter, and the outer diameter of the intermediate portion is less than the outer diameter of the first and second ends.

29. The assembly of claim 27, wherein the coupler has an internal passage extending from the first end to the second end, the first end, the second end, and the intermediate portion each have an average wall thickness, and the average wall thickness of the intermediate portion is less than the average wall thicknesses of the first and second ends.

30. The assembly of claim 27, wherein the first end of the coupler comprises an internally threaded connector, adapted for assembly to an externally threaded connector on the actuator, and the second end of the coupler comprises an externally threaded connector, adapted for assembly to an internally threaded connector on the valve.

31. The assembly of claim 30, wherein the threaded connectors of the valve, actuator, and first and second ends of the coupler have substantially the same thread pitch and diameter.

32. The assembly of claim 30, wherein at least one of the threaded connectors is provided with discontinuous threads.

33. The assembly of claim 27, further comprising:
a movable valve element, disposed within the valve;
a movable actuation element, disposed within the actuator; and
a linking element, disposed between the valve and actuator and having an actuator end that engages the movable actuation element, a valve end that engages the movable valve element, and an intermediate section therebetween.

34. The assembly of claim 33, wherein movement of the movable actuation element is translated to the movable valve element via the linking element.

35. The assembly of claim 33, wherein the linking element is adapted to increase the temperature gradient between the valve and the actuator when one of the valve and the actuator is exposed to an elevated or reduced temperature.

36. The assembly of claim 35, wherein the coupler has an internal passage extending from the first end to the second end and defining an inner surface, and at least a portion of the linking element is disposed in the internal passage.

37. The assembly of claim 36, wherein the intermediate section of the linking element has a wider portion that contacts the inner surface of the coupler and a narrower portion that provides a continuous gap between the narrower portion and the inner surface.

38. The assembly of claim 36, wherein the linking element comprises a plurality of separate linking sections, disposed in series within the internal passage of the coupler.

39. The assembly of claim 38, wherein at least one of the plurality of linking sections possesses a lower thermal conductivity than the remaining linking sections.

40. The assembly of claim 33, wherein at least one of the coupler and the linking element is constructed of a material having structural integrity at elevated temperatures and a low thermal conductivity.

41. The assembly of claim 33, wherein the actuator and the valve are adapted to be assembled directly to each other when the coupler and linking element are removed from the assembly, forming a non-thermally isolated assembly.

42. The assembly of claim 41, further comprising a heat source for heating the valve at a predetermined distance from the movable valve element, wherein a power input is supplied to the heat source to maintain the valve at a predetermined temperature.

43. The assembly of claim 42, wherein the power input required to maintain the movable valve element of the assembly at a temperature of 200° C. is less than 50% of the power required to maintain the movable valve element of the non-thermally isolated assembly at a temperature of 200° C.

44. The assembly of claim 33, wherein continued exposure of the movable valve element to a temperature of 200° C. produces a temperature differential of greater than 100° C. from the first end of the coupler to the second end of the coupler.

45. The assembly of claim 33, wherein continued exposure of the movable valve element to a temperature of 200° C. produces a maximum temperature differential across the valve of 30° C.

46. A valve and an actuator assembly, the assembly comprising:
a valve;
an actuator;
a plurality of thermal isolation subassemblies, each subassembly comprising a coupler, an actuator adapter, and a bonnet adapter, wherein
the coupler of each subassembly engages with the actuator adapter and the bonnet adapter of that subassembly to provide a connection between the actuator adapter and the bonnet adapter of that subassembly, and
the thermal isolation subassemblies are assembled in series, such that
the bonnet adapter of one of the plurality of subassemblies is assembled to the valve and each of the bonnet adapters of the remaining subassemblies is assembled to the actuator adapter of a subsequent subassembly, and
the actuator adapter of another one of the plurality of subassemblies is assembled to the actuator and each of the actuator adapters of the remaining subassemblies is assembled to the bonnet adapter of a preceding subassembly.

47. The assembly of claim 46, wherein at least one of the couplers, the actuator adapters, and the bonnet adapters is constructed of a material having structural integrity at elevated temperatures and a low thermal conductivity.

48. The assembly of claim 46, wherein the coupler and actuator adapter of each subassembly are provided with mating threaded portions.

49. The assembly of claim 48, wherein the coupler and bonnet adapter of each subassembly are provided with overlapping annular flanges.

50. The assembly of claim 49, further comprising a thermal insulating member disposed between the overlapping flanges of the coupler and bonnet adapter of each subassembly.

51. The assembly of claim 50, further comprising a thermal insulating member disposed between an end surface of the actuator adapter and the annular flange of the bonnet adapter.

52. The assembly of claim 51, wherein at least one of the thermal insulating members possesses a lower thermal conductivity than the coupler, the actuator adapter, and the bonnet adapter.

53. In a valve assembly of the type comprising a valve and an actuator, the improvement comprising:
a coupler that mechanically joins the valve to the actuator and increases the temperature gradient between the valve and the actuator when one of the valve and the actuator is exposed to an elevated or reduced temperature.

54. The valve assembly of claim 53, wherein the coupler comprises a first end assembled to the actuator, a second end assembled to the valve, and an intermediate portion disposed between the first and second ends, and the first end, the second end, and the intermediate portion each have an outer diameter, and the outer diameter of the intermediate portion is less than the outer diameter of the first and second ends.

55. The valve assembly of claim 53, wherein the coupler has an internal passage defining an inner surface, the first end, the second end, and the intermediate portion each have an average wall thickness, and the average wall thickness of the intermediate portion is less than the average wall thickness of the first and second ends.

56. The valve assembly of claim 53, wherein the coupler is constructed of a material having structural integrity at elevated temperatures and a low thermal conductivity.

57. The valve assembly of claim 53, further comprising a movable actuator element, disposed within the actuator, a movable valve element, disposed within the valve, and a linking element, disposed between the valve and the actuator and having an actuator end that engages the movable actuator element and a valve end that engages the movable valve element, wherein movement of the movable actuator element is translated to the movable valve element via the linking element.

58. The valve assembly of claim 57, wherein at least one of the coupler and the linking element is constructed of a material having structural integrity at elevated temperatures and a low thermal conductivity.

59. The valve assembly of claim 57, wherein the coupler has an internal passage defining an inner surface, and at least a portion of the linking element is disposed in the internal passage.

60. The valve assembly of claim 57, wherein the linking element further comprises an intermediate section disposed between the actuator end and the valve end, and the intermediate section has a wider portion that contacts the inner surface of the coupler and a narrower portion that provides a continuous gap between the narrower portion and the inner surface.

61. A valve and actuator assembly comprising:
a valve;
an actuator;
means for mechanically joining the valve to the actuator, wherein
said means increases the temperature gradient between the valve and the actuator when one of the valve and the actuator is exposed to an elevated or reduced temperature.

62. A thermal isolator for a valve and an actuator, the thermal isolator comprising:
a body, adapted to be disposed between the valve and the actuator, wherein
the thermal isolator is adapted to increase the temperature gradient between the valve and the actuator when one of the valve and the actuator is exposed to an elevated or reduced temperature.

63. The thermal isolator of claim 62, wherein the body is constructed of a material having structural integrity at elevated temperatures and a low thermal conductivity.

64. The thermal isolator of claim 63, wherein the body material is selected from a group including low thermal conductivity plastics, structural ceramic materials, stainless steels, porous materials, and reinforced composites.

65. A thermal isolator for a valve and an actuator, the thermal isolator comprising:
a body, adapted to be disposed between the valve and the actuator, wherein
the thermal isolator is adapted to provide a thermal barrier between the valve and the actuator when one of the valve and the actuator is exposed to an elevated or reduced temperature.

66. The thermal isolator of claim 65, wherein the body is constructed of a material having structural integrity at elevated temperatures and a low thermal conductivity.

67. The thermal isolator of claim 66, wherein the body material is selected from a group including low thermal conductivity plastics, structural ceramic materials, stainless steels, porous materials, and reinforced composites.
